(19) United States
(12) Patent Application Publication
(10) Pub. No.: US 2025/0299304 A1
(43) Pub. Date: Sep. 25, 2025

(54) ELECTRONIC DEVICE AND METHOD FOR RESTORING IMAGE USING IMAGE RESTORATION MODEL PARTIALLY TRAINED USING BACK PROPAGATION

(71) Applicant: THINKWARE CORPORATION, Seongnam-si (KR)

(72) Inventors: Dongwoo PARK, Seongnam-si (KR); Sukpil KO, Seongnam-si (KR)

(21) Appl. No.: 19/087,462

(22) Filed: Mar. 22, 2025

(30) Foreign Application Priority Data
Mar. 25, 2024 (KR) 10-2024-0040707

(51) Int. Cl. G06T 5/60; G06N 3/084; G06V 10/80; G06V 20/62

(52) U.S. Cl. CPC G06T 5/60; G06N 3/084; G06V 10/806; G06V 20/625

(57) ABSTRACT

An electronic device may: obtain, from an image, a sub-model trained to output a text probability map indicating one or more characters associated with the image; obtain, using an input image with a first resolution, an output image with a second resolution larger than the first resolution by executing an image restoration model including an encoder to extract feature information from the input image, a composite module to combine the text probability map of the sub-model for the input image and the feature information, and a decoder connected to the composite module; generate information indicating a result of comparison of a ground truth image corresponding to the input image and the output image; and perform training on the image restoration model by performing back propagation based on the generated information along a first direction, out of the first direction and a second direction.

### CROSS-REFERENCE TO RELATED APPLICATIONS

This application is based on and claims priority under 35 U.S.C. § 119 to Korean Patent Application No. 10-2024-0040707, filed on Mar. 25, 2024, in the Korean Intellectual Property Office, the disclosure of which is incorporated by reference herein in its entirety.

### BACKGROUND

### Field

The disclosure relates to an electronic device and method for restoring an image using an image restoration model partially trained using back propagation.

### Description of Related Art

Technologies are being developed to process photos and/or videos using artificial intelligence. For example, technologies are being developed to classify subjects (e.g., objects including people, animals, and/or vehicles) captured in photos and/or videos. For example, technologies are being developed to recognize one or more characters (or strings) associated with photos and/or videos.

The above-described information may be provided as related art for the purpose of helping understanding of the disclosure. No claim or determination is made as to whether any of the foregoing is applicable as background art in relation to the disclosure.

### SUMMARY

In an embodiment, a method of an electronic device may be provided. The method may comprise obtaining, from an image, a sub-model trained to output a text probability map indicating one or more characters associated with the image. The method may comprise obtaining, using an input image with a first resolution, an output image with a second resolution larger than the first resolution by executing an image restoration model including an encoder to extract feature information from the input image, a composite module to combine the text probability map of the sub-model for the input image and the feature information, and a decoder connected to the composite module. The method may comprise generating information indicating a result of comparison of a ground truth image corresponding to the input image and the output image. The method may comprise performing training on the image restoration model by performing back propagation based on the generated information along a first direction, out of the first direction from the composite module to the sub-model and a second direction from the composite module to the encoder.

According to an embodiment, an electronic device may comprise memory storing instructions and at least one processor configured to execute the instructions. The instructions may, when executed by the at least one processor individually or collectively, cause the electronic device to obtain, from an image, a sub-model trained to output a text probability map indicating one or more characters associated with the image. The instructions may, when executed by the at least one processor individually or collectively, cause the electronic device to obtain, using an input image with a first resolution, an output image with a second resolution larger than the first resolution by executing an image restoration model including an encoder to extract feature information from the input image, a composite module to combine the text probability map of the sub-model for the input image and the feature information, and a decoder connected to the composite module. The instructions may, when executed by the at least one processor individually or collectively, cause the electronic device to generate information indicating a result of comparison of a ground truth image corresponding to the input image and the output image. The instructions may, when executed by the at least one processor individually or collectively, cause the electronic device to perform training on the image restoration model by performing back propagation based on the generated information along a first direction, out of the first direction from the composite module to the sub-model and a second direction from the composite module to the encoder.

In an embodiment, there may be provided a non-transitory computer-readable storage medium including instructions. The instructions may, when executed by the at least one processor of the electronic device individually or collectively, cause the electronic device to receive a request to restore a first image with a first resolution to an image with a second resolution larger than the first resolution. The instructions may, when executed by the at least one processor individually or collectively, cause the electronic device to, based on the received request, execute an image restoration model including an encoder to extract feature information from the first image, a sub-model to determine text probability map with respect to the first image, a fusion layer to combine the text probability map and the feature information, and a decoder connected to the composite module to generate an image with the second resolution. The instructions may, when executed by the at least one processor individually or collectively, cause the electronic device to provide a second image with the second resolution, which is obtained based on execution of the image restoration model, as a response to the request. The image restoration model may be trained based on back propagation performed along a first direction, out of the first direction from the composite module to the sub-model and a second direction from the composite module to the encoder.

According to an embodiment, an electronic device may comprise memory storing instructions and at least one processor configured to execute the instructions. The instructions may, when executed by the at least one processor individually or collectively, cause the electronic device to receive a request to restore a first image with a first resolution to an image with a second resolution larger than the first resolution. The instructions may, when executed by the at least one processor individually or collectively, cause the electronic device to, based on the received request, execute an image restoration model including an encoder to extract feature information from the first image, a sub-model to determine text probability map with respect to the first image, a fusion layer to combine the text probability map and the feature information, and a decoder connected to the composite module to generate an image with the second resolution. The instructions may, when executed by the at least one processor individually or collectively, cause the electronic device to provide a second image with the second resolution, which is obtained based on execution of the image restoration model, as a response to the request. The image restoration model may be trained based on back propagation performed along a first direction, out of the first direction from the composite module to the sub-model and a second direction from the composite module to the encoder.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exemplary block diagram illustrating an electronic device for restoring at least a portion of an image;

FIG. 2 is an exemplary block diagram illustrating a structure of an image restoration model executed by an electronic device according to an embodiment;

FIG. 3 illustrates an exemplary operation of changing at least a portion of an image restoration model using back propagation;

FIG. 4 illustrates an exemplary operation of an electronic device to restore an image using an image restoration model at least partially trained using back propagation;

FIG. 5 is an exemplary block diagram illustrating an image restoration model connected to a teacher model; and

FIG. 6A illustrates at least one license plate (or number plate) which is an object included in an image restored by an image restoration model according to an embodiment.

FIG. 6B illustrates at least one license plate (or number plate) which is an object included in an image restored by an image restoration model according to an embodiment.

### DETAILED DESCRIPTION

Hereinafter, embodiments of the disclosure are described with reference to the accompanying drawings.

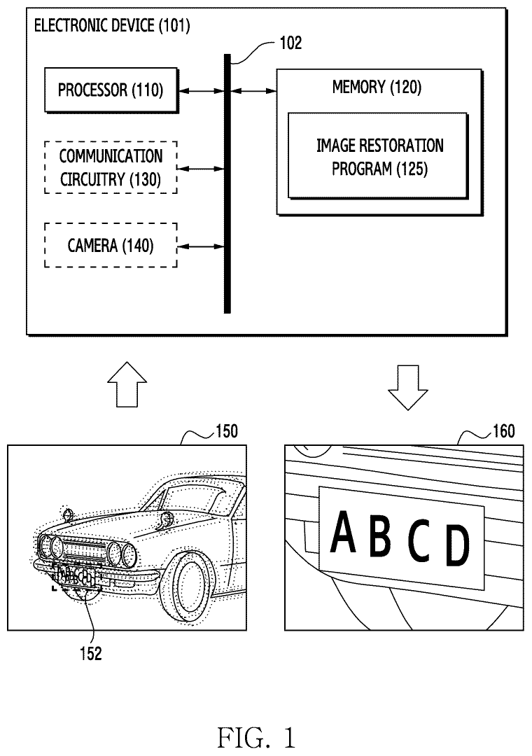

FIG. 1 is an exemplary block diagram illustrating an electronic device 101 for restoring at least a portion of an image 150. The electronic device 101 may be configured to at least partially restore or enhance the image 150. Restoring or enhancing the image 150 may include an operation of enhancing the visibility of the subject represented by the image 150 by compensating for distortion included in the image 150, such as blur, ghosting, or optical flow.

Referring to FIG. 1, an image 150 including a portion 152 related to a license plate (or number plate) is illustrated as an example. For example, the image 150 may be transmitted from an external electronic device to the electronic device 101 through the communication circuitry 130. For example, the image 150 may be obtained by the camera 140 included in the electronic device 101. For example, the image 150 may be a file in a format based on a format for compressing and storing digital images, such as joint photographic experts group (jpeg), portable network graphics (PNG), etc. For example, the image 150 may include raw data obtained from the camera 140. For example, the image 150 may be a sequence (e.g., video) of image frames, which are included in a video and are configured to be displayed sequentially. The means for obtaining or receiving the image 150 is not limited to the communication circuitry 130 and/or the camera 140 illustrated in FIG. 1.

Referring to the exemplary image 150 of FIG. 1, an exemplary subject, such as a vehicle, may be captured. Depending on the environment in which the subject is photographed, the image 150 may be distorted. For example, when the subject moves (e.g., a vehicle drives), and/or a camera (e.g., the camera 140) controlled to obtain the image 150 is moved (or shaken), the appearance of the subject represented by the pixels of the image 150 may be distorted. According to an embodiment, the electronic device 101 may at least partially reduce or remove the distortion occurring in the image 150 to make the appearance of the subject represented by the image 150 clear.

Referring to FIG. 1, an exemplary hardware configuration of the electronic device 101 for at least partially restoring the image 150 is illustrated. For example, the electronic device 101 may include a personal computer (PC), such as a laptop and a desktop, a smartphone, a smartpad, or a tablet PC. For example, the electronic device 101 may include a smart accessory, such as a smartwatch, a smart ring, and/or a head-mounted device (HMD). For example, the electronic device 101 may be referred to as a mobile device, a user device (or user equipment (UE)), a multifunctional device, a portable communication device, and/or a portable device. For example, the electronic device 101 may be included as an electronic control unit (ECU) in a vehicle (e.g., an electric vehicle (EV)). For example, the electronic device 101 may include a server of a service provider that provides a service for restoring the image 150. The server may include one or more PCs and/or workstations.

Referring to FIG. 1, according to an embodiment, the electronic device 101 may include at least one of a processor 110, a memory 120, communication circuitry 130, or a camera 140. In an embodiment, the communication circuitry 130 and/or the camera 140 may not be included in the electronic device 101. For example, the communication circuitry 130 and/or the camera 140 may be disposed outside the electronic device 101 and may be electrically connected to the electronic device 101.

Referring to FIG. 1, the processor 110, the memory 120, the communication circuitry 130, and a camera 140 may be electrically and/or operatively connected to each other by an electronic component such as a communication bus 102. Hereinafter, operative coupling of electronic components may mean that a direct or indirect connection between first electronic components and second electronic components is established wiredly or wirelessly so that the second electronic component is controlled by the first electronic component. Although illustrated based on different blocks, the embodiments are not limited thereto, and some (e.g., at least a portion of the processor 110, the memory 120, and the communication circuitry 130) of the electronic components of FIG. 1 may be included in a single integrated circuit like a system on chip (SoC). The type and/or number of the electronic components included in the electronic device 101 is not limited as illustrated in FIG. 1. For example, the electronic device 101 may include only some of the electronic components illustrated in FIG. 1.

According to an embodiment, the processor 110 of the electronic device 101 may include a circuit (e.g., a processing circuit) for processing data based on one or more instructions. For example, the circuit for processing data may include an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of processors 110 may be one or more. The processing circuit of the processor 110 that loads (or fetches) instructions and performs calculations corresponding to the loaded instructions may be denoted or referred to as a core circuit (or core). For example, the processor 110 may have a structure of a multi-core processor including a plurality of core circuits, such as a dual core, a quad core, a hexa core, or an octa core. The functions and/or operations described with reference to the disclosure may be individually and/or collectively performed by one or more processing circuits included in the processor 110.

According to an embodiment, the memory 120 of the electronic device 101 may include a circuit for storing data and/or instructions input and/or output to/from the processor 110. The memory 120 may include, e.g., volatile memory such as random-access memory (RAM), and/or non-volatile memory such as read-only memory (ROM). The non-volatile memory may be referred to as storage. The volatile memory may include, e.g., at least one of dynamic RAM (DRAM), static RAM (SRAM), cache RAM, and pseudo SRAM (PSRAM). The non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC). The memory 120 may include one or more storage media (e.g., the above-described volatile memory and/or non-volatile memory) positioned in a distributed scheme in the electronic device 101. The processor 110 of the electronic device 101 may execute instructions of the memory 120 in the electronic device 101 to perform functions and/or operations indicated by the instructions. For example, when the electronic device 101 includes at least one processor, the at least one processor may be configured to execute the instructions collectively or individually.

According to an embodiment, the communication circuitry 130 of the electronic device 101 may include hardware for transmitting and/or receiving electric signals between the electronic device 101 and external electronic device (e.g., a user terminal configured to transmit the image 150). The communication circuitry 130 may include at least one of, e.g., a modem, an antenna, and an optic/electronic (O/E) converter. The communication circuitry 130 may support transmission and/or reception of electric signals based on various types of protocols such as Ethernet, local area network (LAN), wide area network (WAN), wireless fidelity (Wi-Fi), near-field communication (NFC), Bluetooth, Bluetooth low energy (BLE), ZigBee, long term evolution (LTE), fifth generation (5G) new radio (NR), sixth generation (6G), and/or above-6G.

According to an embodiment, the camera 140 of the electronic device 101 may include one or more optical sensors (e.g., a charged device (CCD) sensor and a component metal oxide semiconductor (CMOS) sensor) that generate an electrical signal indicating the color and/or brightness of light. The plurality of optical sensors included in the camera 140 may be arranged in the form of a two-dimensional array. The camera 140 may obtain the respective electrical signals of the plurality of optical sensors substantially simultaneously to generate two-dimensional (2D) frame data corresponding to light reaching the optical sensors of the 2D array. For example, photo data captured using the camera 140 may mean one (a) 2D frame data obtained from the camera 140. For example, video data captured using the camera 140 may mean a sequence of a plurality of 2D frame data obtained from the camera 140.

Referring to FIG. 1, the processor 110 of the electronic device 101 according to an embodiment may execute an image restoration program 125 to at least partially restore or enhance the image 150. The processor 110 (e.g., CPU, GPU, and/or NPU) that has executed the image restoration program 125 may perform calculations for restoring the image 150. The calculations may be related to a computational model (e.g., an artificial natural network, and/or a neural network) configured to simulate the neural activity of an organism. The computational model may be referred to as a model. Each of the operations set to be continuously calculated by the computational model may be referred to as a module. The computational model may be defined by a program readable by the processor 110. The neural activity may include, e.g., a cognitive activity, an inference activity, and/or a creative activity of an organism. For example, instructions representing the computational model, formulas related to the computational model, and/or constants (e.g., coefficients and/or weights) included in the formulas may be at least partially included in the image restoration program 125.

According to an embodiment, the processor 110 of the electronic device 101 may restore, or reinforce, a portion 152 where at least one character is captured (e.g., a portion where an object printed with one or more characters have been captured such as a license plate and/or a sign board) in the image 150. For example, in the image 150, the electronic device 101 may extract or segment (or crop) a portion 152 related to at least one character. The portion 152 may be referred to as a region of interest (ROI). The processor 110 may restore or enhance the portion 152 by executing the image restoration program 125.

In an embodiment, the electronic device 101 may increase or enhance the resolution of the scene by recognizing text related to a scene such as an image 150 (e.g., text captured or included in the scene). For example, when detecting one or more characters from a scene with a relatively low resolution (or a small size), electronic device 101 may use the shape and/or appearance of one or more characters detected to generate another scene that corresponds to the scene and has a higher resolution (or larger size) than the resolution of the scene. For example, for a scaling factor f, from a scene with a width w and a height h, the electronic device 101 may generate or output a scene with a width fw and a height fh.

In an embodiment, in terms of recognizing text and generating a high-resolution scene, the image restoration program 125 and/or the artificial intelligence driven by the image restoration program 125 may be referred to as a scene text image super-resolution (STISR) and/or a model for STISR. The performance of STISR may be evaluated using the accuracy (e.g., STISR acuity) of characters included in the super-resolution image (or restored image) generated by executing STISR.

Referring to FIG. 1, an image 160 that the electronic device 101 outputs as a result of restoring the portion 152 of the image 150 is illustrated. The image 150 and/or the portion 152 may be referred to as an input image in terms of being input to the processor 110 of the electronic device 101. The image 160 may be referred to as an output image in terms of output data corresponding to the input image. According to an embodiment, the electronic device 101 may obtain information representing one or more characters related to the portion 152 using an artificial intelligence model trained to recognize one or more characters from an image. The electronic device 101 may generate or output an image 160 as a high-resolution image corresponding to the portion 152, using the information.

Referring to FIG. 1, the image 160 may have a size larger than that of the portion 152 and/or a resolution higher than that of the portion 152. The dimensions (e.g., width and/or height) of the image 160 may be larger than the dimensions of the portion 152. For example, the image 160 may have the same dimensions and/or resolution as the image 150. In an embodiment of receiving the image 150 and/or the portion 152 from an external electronic device through the communication circuitry 130, the electronic device 101 may receive a request to restore the portion 152 of the image 150 having a first resolution to the image 160 having a second resolution exceeding the first resolution. From the signal received from the external electronic device, the electronic device 101 may identify or detect the image 150 and/or the portion 152. The signal may include a command and/or an operand indicating a request for restoration of the portion 152. In an embodiment of receiving the entire image 150 including the portion 152, the processor 110 of the electronic device 101 may extract or segment a portion 152 where a subject related to one or more characters is captured, such as a number plate. The portion 152 may be used as an image used for restoration.

Based on the request for restoring the image 150 and/or the portion 152, the electronic device 101 may execute an artificial intelligence model (e.g., an image restoration model) provided by the image restoration program 125. The electronic device 101 may provide the image 160 of the second resolution, obtained based on the execution of the image restoration model, in response to the request. For example, the electronic device 101 may transmit a signal including the image 160 to an external electronic device through the communication circuitry 130.

In an embodiment, the image restoration model executed by the image restoration program 125 may include a sub-model trained to recognize one or more characters associated with the input image (e.g., the portion 152 and/or image 150 including the portion 152) inputted to the image restoration model (e.g., represented as captured by the input image). The sub-model may be trained to output information representing one or more characters related to the input image, degrees (e.g., the probabilities that one or more characters are to be captured by the input image) to which each of the one or more characters is related to the input image, and/or the positional relationship (e.g., the position and/or order of each of the one or more characters in the string), as information (e.g., explicit information) readable by the processor 110 executing a software application distinct from the image restoration model and/or the image restoration program 125.

For example, the information output from the sub-model may be referred to as text probability information in terms of including probabilities indicating text indicated as captured by the input image. The text probability information may be referred to as text categorical information, text probability, text probability map, text prior information, and/or text distribution. For example, text probability information may include categorical information about text and/or information indicating a visual cue for text in an image.

According to an embodiment, the electronic device 101 may perform additional training on the sub-model trained to output explicit information such as text probability information. The additional training may be performed preferentially (or selectively or differentially) on training of other sub-models included in the image restoration model. The additional training may be performed by selectively changing parameters (e.g., weights) related to the sub-model among parameters related to the image restoration model.

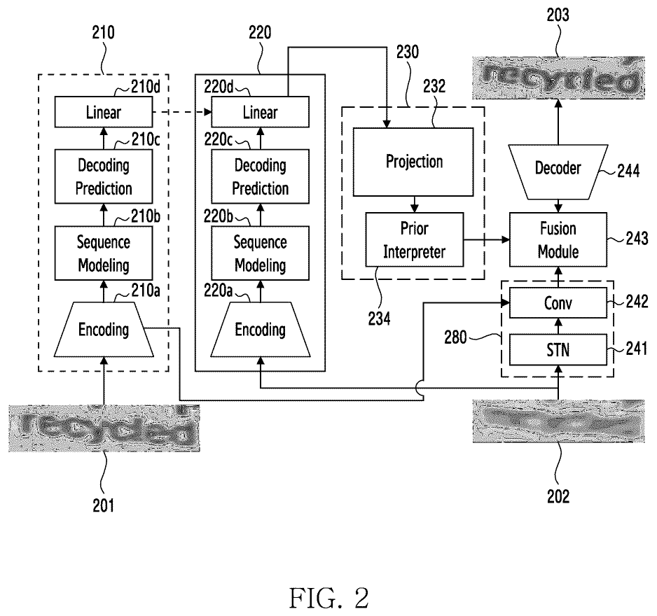

Hereinafter, the structure of the image restoration model executed by the electronic device 101 according to an embodiment and the operation of training the image restoration model are exemplarily described with reference to FIGS. 2 to 5.

FIG. 2 is an exemplary block diagram illustrating a structure of an image restoration model executed by an electronic device (e.g., the electronic device 101 of FIG. 1) according to an embodiment. The electronic device 101 and/or the processor 110 of FIG. 1 may execute the image restoration program 125 to execute the image restoration model described with reference to FIG. 2.

Hereinafter, the operation of executing an artificial intelligence model, such as an image restoration model, may include operations of performing one or more calculations related to the artificial intelligence model using a processor of an electronic device (e.g., the processor 110 of FIG. 1 including a GPU and/or an NPU). The operation of executing the artificial intelligence model may include inputting commands (or instructions) representing the calculations to the GPU and/or NPU to perform the calculations by the GPU and/or the NPU. The operation of executing the artificial intelligence model may include inputting data (e.g., an input image such as the image 150 and/or the portion 152 of FIG. 1) to be at least partially changed by the calculations to the GPU and/or the NPU. Although the operation of executing the artificial intelligence model based on the GPU and/or the NPU has been exemplarily described, embodiments are not limited thereto, and the operation of executing the artificial intelligence model using the CPU may also be performed similar to the above-described operations.

Referring to FIG. 2, the calculations performed by the image restoration model are shown as a plurality of blocks for distinguishing the types and/or orders of the calculations. Any one block of FIG. 2 may correspond to a group of calculations performed while executing the artificial intelligence model (e.g., the image restoration model). Each of the blocks of FIG. 2 may be referred to as an operation, layer(s), sub-model and/or module for an artificial intelligence model. Referring to FIG. 2, an image restoration model including a teacher-model 210 connected to the image restoration model is exemplarily illustrated to train at least a portion of the image restoration model.

For example, the image restoration model may include an encoder 280 (e.g., a combination of a spatial transformer networks (STN) operation 241 and a convolution operation 242) for extracting feature information from an image. The encoder 280 including the STN operation 241 and/or the convolution operation 242 may include a shallow convolutional natural network (CNN) with less loss of structural information (or spatial information) required for image restoration. The shallow CNN may include fewer layers than a backbone network (e.g., ResNet including 50 or more convolutional layers) with a structure where a large number of layers are serially connected for feature extraction. The encoder (or STISR) of the image restoration model may include a relatively small number of layers to reduce the loss of structural information (or spatial information) of the low-resolution image when extracting features of the low-resolution image to perform a low-level vision task (e.g., a task increasing the resolution of the image). By executing the encoder 280 of the image restoration model, the electronic device may generate or obtain feature information about the input image 202. The feature information may include summarized (or dimension-reduced) information about the input image 202 to specify or distinguish the input image 202. The feature information may include positions and/or characteristics of one or more pixels uniquely included in the input image 202, such as a feature point or key point and/or a boundary line.

For example, the image restoration model may include a sub-model 220 for determining a text probability map for the input image 202. The teacher-model 210 may generate training information (e.g., ground truth data and input data corresponding to the ground truth data) used to train the sub-model 220 using knowledge distillation. The numbers of calculations of the sub-model 220 and the parameters (e.g., coefficients and/or weights) used in the calculations may be smaller than the numbers of calculations of the teacher-model 210 and parameters used in the calculations of the teacher-model 210. For example, the sub-model 220 may be pre-trained by the teacher-model 210, which is executed using more parameters than the parameters for the sub-model 220.

In an embodiment, the teacher-model 210 used for training the sub-model 220 may be trained to recognize one or more characters from a scene such as the image 201. In terms of character recognition, the teacher-model 210 and/or the sub-model 220 may be referred to as a scene-text recognizer (STR) and/or a STR model (or a recognizer). The teacher-model 210 may be configured to recognize or process features such as shapes and/or positions of one or more characters in the image 201.

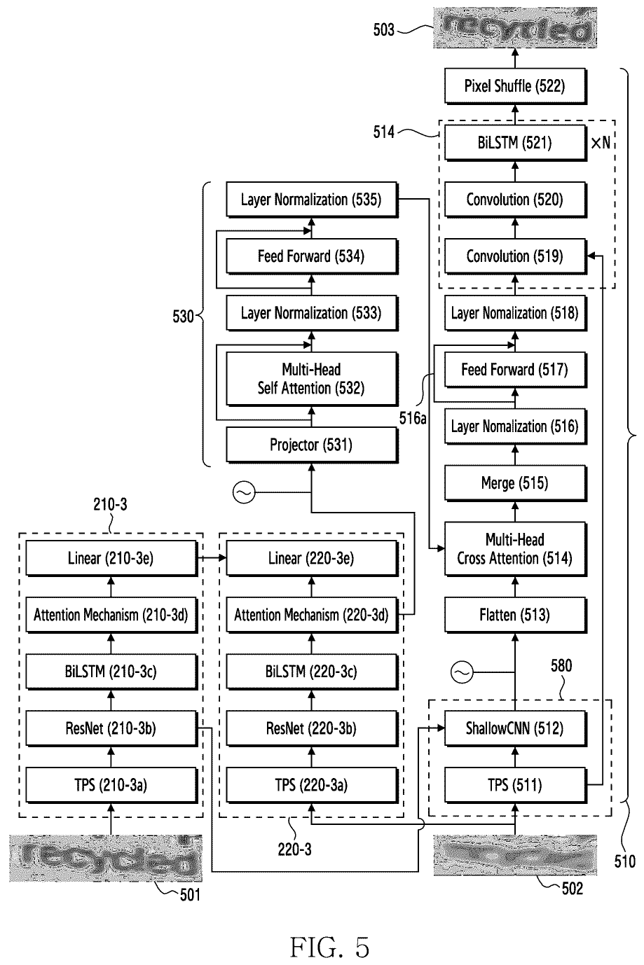

Referring to FIG. 2, the types and orders of calculations of teacher-model 210 and sub-model 220 may be similar or identical to each other. For example, when executing sub-model 220, the electronic device may obtain or generate output data (e.g., text probability information and/or text probability map) by sequentially performing encoding operation 220a, sequence modeling operation 220b, decoding prediction operation 220c, and linearization operation 220d on the input image 202. The operations (e.g., encoding operation 220a, sequence modeling operation 220b, decoding prediction operation 220c, and linearization operation 220d) performed sequentially in the sub-model 220 may correspond to operations (e.g., encoding operation 210a, sequence modeling operation 210b, decoding prediction operation 210c, and linearization operation 210d), respectively, performed sequentially in the teacher-model 210. The connection of the above-described operations may have a structure of TRBA (TPS (thin plate spline transformation)-ResNet (Residual neural Network)-BiLSTM (bidirectional long-short term memory)-attention mechanism). An exemplary structure of the sub-model 220 having a structure of TRBA is described in detail with reference to FIG. 5. Embodiments are not limited thereto, and other structures (or topologies) such as CRNN (convolution-recurrent natural network), ABINet (autonomous, bidirectional and altruistic network), and/or PARseq (permuted autoregressive sequence) may be applied to the structure of sub-model 220. The output layer of sub-model 220 may include values determined by calculations performed for the linearization operation. Values included in the output layer may be text probability information.

According to an embodiment, the electronic device may train the sub-model 220 using the teacher-model 210 into which the image 201 having a relatively high resolution is input. For example, the electronic device that has executed the teacher-model 210 may determine, from the image 201, a text probability map representing one or more characters related to the image 201. The electronic device may train the sub-model 220 using another image having a lower resolution than the image 201 and the determined text probability map.

Referring to FIG. 2, the output layer of the sub-model 220 may be related to the linearization operation 220d. In the sub-model 220, implicit information, including the result of performing the decoding prediction operation 220c (or the state of any one intermediate layer for the decoding prediction operation 220c), may be provided to the composite module 243 to be used in the linearization operation 220d. Prior to being provided to the composite module 243, implicit information may be input to the projection model 230. By using the projection model 230, the electronic device may sequentially perform a projection operation 232 and a prior interpreter operation 234 on the implicit information. Intrinsic information that is at least partially changed by the projection model 230 may be input to the composite module 243. The combination of the sub-model 220 and the projection model 230 may be referred to as a scene-text recognizer (STR). Information output by the projection model 230 (e.g., information transmitted from the projection model 230 to the composite module 243) may be referred to as prior knowledge information.

The combination of the sub-model 220 and the projection model 230 may cause the electronic device executing the image restoration model to generate an output image 203 using textual information (e.g., text probability information) inferred from the input image 202. The encoder 280, which is a combination of spatial transformer networks (STN) operation 241 and convolution operation 242, may cause the electronic device executing the image restoration model to generate an output image 203 using non-textual information (e.g., structural information) inferred from the input image 202. In terms of using both textual information and non-textual information, the image restoration model may be a model supporting multimodal.

According to an embodiment, the image restoration model executed by the electronic device may be trained to generate the output image 203 using textual information (e.g., feature information generated by the combination of the sub-model 220 and the projection model 230) and non-textual information (e.g., feature information input from the encoder 280 to the composite module 243) extracted from the input image 202. For example, an image restoration model may be trained so that the output image 203 has a resolution higher than the resolution of the input image 202, or a size larger than the size of the input image 202, and the content of the input image 202 is maintained in the output image 203.

For example, textual information includes only information to distinguish one or more characters indicated as captured by input image 202, and non-textual information may include structural information (e.g., color distribution, shape, angle, content, and/or background) of the input image 202. For example, when reinforcing or restoring the input image 202 using the image restoration model, the utilization rate of the non-textual information, out of the textual information and the non-textual information, may increase. In an embodiment, the training of the image restoration model may include an operation (or process) for increasing or maximizing the utilization rate of the textual information. For example, the image restoration model may be trained to reduce or prevent imbalanced (or biased) utilization between the textual and non-textual information. For example, the image restoration model may be trained to increase the accuracy of restoring the output image 203 from the input image 202 using the textual information. In terms of maximizing the utilization rate of text prior information, the image restoration model may be referred to as a PURE (Prior Utilization RatE Maximization) model.

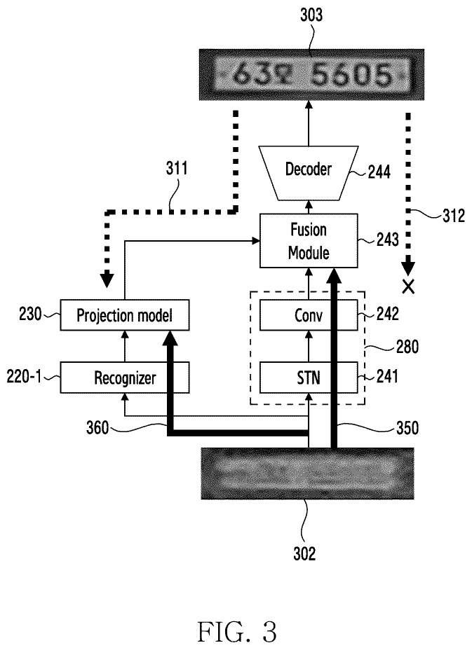

For example, the image restoration model may be trained to output the output image 203 as a result of enhancing the input image 202 by a training process including a first step (e.g., pretraining step) of training the sub-model 220, a second step of selectively training a portion of the image restoration model to increase the utilization rate of the trained sub-model 220, and a third step of training the entire image restoration model including the sub-model 220 trained in the second step. The first step of training the sub-model 220 may be performed using knowledge distillation based on the teacher-model 210. Hereinafter, the second step and/or third step of the training process is described with reference to FIG. 3.

FIG. 3 illustrates an exemplary operation of changing at least a portion of an image restoration model using back propagation. The electronic device 101 and/or the processor 110 of FIG. 1 may execute the image restoration program 125 to obtain or execute an image restoration model trained by the exemplary operation described with reference to FIG. 3. Alternatively, the electronic device 101 and/or the processor 110 of FIG. 1 may execute the image restoration program 125 to perform training on the image restoration model based on the operation described with reference to FIG. 3.

The blocks of FIG. 3 may be classified by operations performed to simulate an image restoration model. Using the encoder 280 (e.g., a combination of the spatial transformer networks (STN) operation 241 and the convolution operation 242), the electronic device may extract low-level feature information from the input image 302. By combining the feature information with position embedding data for the synthesis operation, the electronic device may obtain feature information having a dimension (or size) of [symbol] ^{c×hw}. [symbol] ^{c×hw} h and w of may mean the height and width of the input image 302. c of [symbol] ^{c×hw} may mean the number of channels (e.g., the respective three channels of red, green, and blue constituting RGB) of the input image 302. Using the encoder, the electronic device may adjust the shapes of characters in the input image 302 so that the characters have uniform shapes. For example, the information output from the encoder may correspond to Fᵥ of Equation 1, based on a thin plate spline (TPS) operation to control the shapes of the characters in the input image 302.

$${F}_{v} = Flatten ( E n {c}_{1} ( T P S ( {x}_{L R} ) ) + P E ) \qquad [ Equation 1 ]$$

x_{LR} of Equation 1 may denote an input image 302 having a relatively low resolution. The PE of Equation 1 may represent position embedding data combined to feature information. Flatten of Equation 5 may denote an operation of converting multi-dimensional information into one-dimensional information. Enc₁ in Equation 1 may denote an operation performed by the shallow CNN 421. The image restoration model according to an embodiment may consider the proximity between pixels in an image by using position embedding data as an index indicating the importance between pixels in an image. Thus, according to an embodiment, the image restoration model may be trained to use information indicating the spatial characteristics of the image (e.g., PE which is the position embedding data in Equation 1), to consider the distance between pixels in the image while calculating feature information.

In a state of processing the input image 302 using the image restoration model, the electronic device may perform a first operation 350 of obtaining the feature information Fᵥ of Equation 1 using the encoder 280 and a second operation 360 of processing the input image 302 using the sub-model 220-1 (e.g., a student recognizer) in a first state in parallel (or substantially simultaneously). The first operation 350 and the second operation 360 may be performed substantially simultaneously by different processors included in the electronic device. For example, the first state of the sub-model 220-1 may correspond to a state after being pre-trained by the teacher-model (e.g., the teacher-model 210 of FIG. 2). For example, the first state may correspond to the state of the sub-model 220-1 trained by the output data t_{HR} of the teacher-model in Equation 2.

$${t}_{H R} = S T {R}_{tea} ( {x}_{H R} ) \qquad [ Equation 2 ]$$

x_{HR} of Equation 2 may correspond to an image (e.g., the image 201 of FIG. 2) having a high resolution (e.g., a resolution higher than the input image 302) inputted to the teacher-model 220-1. STRₜₑₐ of Equation 2 may denote an operation performed in the teacher-model (e.g., the teacher-model 210 of FIG. 2). The first state of the sub-model 220-1 may correspond to a state before being trained by information back-propagated (e.g., back propagation in the first direction 311 and/or the second direction 312) from another portion of the image restoration model.

Similar to Equation 2, the feature information t_{LR} obtained from the sub-model 220-1 may be defined as Equation 3.

$${t}_{LR} = {STR}_{stu} ( {x}_{LR} ) \qquad [ Equation 3 ]$$

x_{LR} of Equation 3 may denote an input image 302 having a low resolution. t_{LR} of Equation 3 may denote logit information output from the sub-model 220-1.

For example, feature information t_{HR} obtained from a high-resolution image x_{HR} may be obtained by executing a fixed (or frozen) teacher-model, and feature information t_{LR} obtained from a low-resolution image x_{LR} may be obtained by executing a trainable sub-model 220-1. The electronic device may perform training on the sub-model 220-1 based on knowledge distillation using the loss function [symbol] _{distill} of Equation 4.

$${ℒ}_{distill} = {\vert {t}_{HR} - {t}_{LR} \vert}_{1} + {D}_{KL} ( {t}_{LR} ‖ {t}_{HR} ) \qquad [ Equation 4 ]$$

Referring to Equation 4, the loss function [symbol] _{distill} may be the sum of the L1 distance between the feature information t_{LR}, t_{HR} (e.g., Manhattan distance and/or rectangular street grid), and Kullback-Leibler (KL) divergence. The sub-model 220-1 in the first state of FIG. 3 may be the sub-model 220-1 in a state trained based on the loss function [symbol] _{distill} of Equation 4. D_{KL} of Equation 4 may denote Kullback-leibler divergence loss

$$( {D}_{KL} ( p ( x ) ‖ q ( x ) ) = {\sum }_{x ∈ X} p ( x ) ln \frac{p ( x )}{q ( x )} ) .$$

|t_{HR}−t_{LR}|₁ of Equation 4 may denote the L1 distance between t_{HR} and t_{LR}.

An embodiment of training the sub-model 220-1 using the teacher-model is described, but embodiments are not limited thereto. For example, the electronic device may perform training on the sub-model 220-1 using the cross-entropy loss between the truth data and the output data of the sub-model 220-1. For example, the loss function [symbol] ₛₜᵣ of Equation 5 may be represented using the cross-entropy loss.

$${ℒ}_{str} = CE ( {t}_{LR ,} {y}_{gt} ) \qquad [ Equation 5 ]$$

y_{gt} of Equation 5 may denote a correct answer label (e.g., ground truth data) for an image received as an input. Referring to FIG. 3, the electronic device may obtain feature information t_{LR}∈ [symbol] about the input image 302 from the sub-model 220-1 in the first state. t_{LR} may be [symbol] logit information output from the sub-model 220-1. For example, t_{LR} may denote a probability [symbol] distribution for text obtained from the sub-model 220-1. I of the size t_{LR}∈ [symbol] of t_{LR} may denote a designated maximum length (e.g., 25) of the string. | [symbol] | of t_{LR}∈ [symbol] may be the number of classes (or categories) of the string (e.g., 36 characters from a to z, and from 0 to 9). | [symbol] | may further include the number of tokens (e.g., start token and/or end of sequence) indicating the start and end of the string. The feature information t_{LR} may correspond to Equation 3 for x_{LR} representing the input image 302.

By performing calculations of the projection model 230 on the feature information t_{LR} obtained from the sub-model 220-1, the electronic device may obtain or calculate the feature information Fₚ″∈ [symbol] ^{l×c} of Equation 6.

$${F}_{p}^{″} = LN ( {F}_{p}^{′} \cdot {W}_{p}^{′} + {F}_{p}^{′} ) \qquad [ Equation 6 ]$$

such that

$${F}_{p}^{′} = LN ( softmax ( \frac{{Q}_{p} \cdot {K}_{p}^{T}}{\sqrt{d}} ) {V}_{p} + {F}_{p} )$$

such that

$${F}_{p} = ( {t}_{LR} + PE ) \cdot {W}_{p}$$

Wₚ of Equation 6 may denote a feed-forward operation. The addition operation of Equation 6 may denote a residual connection (or identity mapping). LN of Equation 6 may mean a layer normalization operation. The feature information Fₚ″ of Equation 6 may be obtained based on multi-head self-attention. Queries, keys, and values, which are vectors necessary to perform multi-head self-attention calculations, may correspond to the feature information Fₚ∈ [symbol] ^{l×c}. Qₚ·Kₚ^{T} of Equation 6 may denote the multi-head self-attention calculation, may have a size of [symbol] ^{l×l}, and Fₚ′ of Equation 6 may have a size of [symbol] ^{l×c}. Qₚ of Equation 6 is a projection of Fₚ (e.g., a projection based on the fc layer), and may denote a query vector. Kₚ^{T} and Vₚ are the projections of Fₚ of Equation 6 (e.g., projections based on the fc layer), and may denote a key vector and a value vector, respectively. The Qₚ·Kₚ^{T} operation of Equation 6 may denote the attention score of the self-attention. The T operation of Equation 6 may denote a matrix transpose operation. d of Equation 6 may denote the dimension of the key vector. Referring to Equation 6, feature information Fₚ″ obtained using a softmax operation and a layer normalization (LN) operation may be obtained from the projection model 230.

The composite module 243 of the electronic device may combine or synthesize the feature information Fₚ″ obtained from the projection model 230 and the feature information Fᵥ obtained from the encoder 280. The composite module 243 may indicate a combination of the feature information Fₚ″ and the feature information Fᵥ based on the multi-head cross attention of Equation 7.

$${F}_{p}^{′′′} = LN ( softmax ( \frac{{Q}_{v} \cdot {K}_{p}^{″ T}}{\sqrt{d}} ) {V}_{p}^{″} ) \qquad [ Equation 7 ]$$

The query vector Qᵥ used to perform the multi-head cross attention of Equation 7 may have a size of Fᵥ·W_{q}_{₂}∈ [symbol] ^{hw×c} for the feature information Fᵥ of Equation 1 and W_{q}_{₂} representing the feed-forward operation. The key vector Kₚ″ used to perform the multi-head cross-attention of Equation 7 may have a size of Fₚ″·Wₖ_{₂}∈ [symbol] ^{l×c} for the feature information Fₚ″ of Equation 6 and Wₖ_{₂} representing the feed-forward operation. The value vector Vₚ″ used to perform the multi-head cross attention of Equation 7 may correspond to Fₚ″·Wᵥ_{₂}∈ [symbol] ^{l×c} for the feature information Fₚ″ of Equation 6 and Wᵥ_{₂} representing the feed-forward operation. Qᵥ·Kₚ″^{T} of Equation 7 may have a size of [symbol] ^{hw×l}. The Qᵥ·Kₚ″^{T} operation of Equation 7 may denote an attention score of self-attention, having a size of [symbol] ^{hw×c}.

The feature information Fₚ′″ of Equation 7 generated by the composite module 243 may be input to the decoder 244. The electronic device may obtain feature information F which is a result of performing the feedforward operation and the layer normalization operation of Equation 8 on the feature information Fₚ′″. Using the obtained feature information F, the electronic device may perform calculations represented by the decoder 244.

$$F = LN ( {F}_{p}^{′′′} \cdot {W}_{f} + {F}_{p}^{′′′} ) \qquad [ Equation 8 ]$$

LN of Equation 8 may denote the layer normalization operation. W_{f} of Equation 8 may denote the feed-forward operation (or an fc layer for the feed-forward operation). In other words, Equation 8 may denote a process of calculating feature information F obtained by normalizing a combination of the feature information Fₚ′″ and a projection (Fₚ′″·W_{f}) of the feature information Fₚ′″ to the feed-forward network. From the decoder 244 to which the feature information F of Equation 8 is input, the electronic device may obtain a high-resolution output image 303. The output image 303 may be represented as Equation 9.

$$Restored Image = PixelSuffle ( SRB ( {F}_{v} , F ) ) \qquad [ Equation 9 ]$$

In Equation 9, F is the final feature of the priority knowledge of Equation 8, and Fᵥ is the final feature of the image. Equation 9 may denote a Pixelshuffle operation for the result of decoding the merged F and Fᵥ using a sequential residual block (SRB). For example, a final restored image (e.g., super resolution image) may be generated through the Pixelshuffle operation.

When back propagation in the direction toward the shallow CNN (e.g., the second direction 312) for feature information is stopped, the rate at which text prior information (or prior modality) is utilized in the image restoration model may increase. For example, the sub-model 220, trained to output text prior information, does not simply output text categorical information, but is directly trained by information suitable for image restoration, and information suitable for image restoration may be output from sub-model 220. For example, the sub-model 220 for text modality may be trained to generate feature information for image reconstruction. Training of the image restoration model may include an operation of stopping where back propagation (e.g., gradient descent) in a direction toward the shallow CNN (e.g., second direction 312) or detaching the shallow CNN to selectively performing training in a direction toward a model that outputs prior information. By the selective training, the rate at which prior information is used in the image restoration model (e.g., the utilization rate) may be maximized. After the selective training, the image restoration model may be further trained by back propagation of the entire model including the shallow CNN.

When training an image restoration model with the structure of FIG. 3 (e.g., the second step and/or third step of the training process), the loss function to be used for training the image restoration model may indicate the difference between the truth image corresponding to the input image 302 and the output image 303. For example, the L1 distance between the truth image and the output image 303 may be determined by the loss function. Embodiments are not limited thereto, and a KL divergence loss function for L2 distance (or mean squared loss), structural similarity index (SSIM), triplex SSIM (TSIM), and knowledge distillation may be used. For example, the loss function [symbol] ₛ based on the L2 distance may be defined as Equation 10.

$${ℒ}_{s} = {\vert {I}_{SR} - {I}_{HR} \vert}_{2} \qquad [ Equation 10 ]$$

I_{SR} of Equation 10 may denote the output image 303, and I_{HR} may denote the truth image. The operation |I_{SR}−I_{HR}|₂ of Equation 10 may denote the L2 distance (or L2 loss or mean square error (MSE) loss) between I_{SR} and I_{HR}. The sub-model 220-1 and/or the image restoration model may be trained to minimize the loss function [symbol] ₛ of Equation 10. Embodiments are not limited thereto, and a loss function based on TSSIM, such as the loss function [symbol] ₜₛₛᵢₘ of Equation 11, may be used.

$${ℒ}_{tssim} = 1 - TSSIM \qquad [ Equation 11 ]$$

such that

$$TSSIM = \frac{( {μ}_{x} {μ}_{y} + {μ}_{y} {μ}_{z} + {μ}_{x} {μ}_{z} + {C}_{1} ) ( {σ}_{xy} + {σ}_{yz} + {σ}_{xz} + {C}_{2} )}{( {μ}_{x}^{2} + {μ}_{y}^{2} + {μ}_{z}^{2} + {C}_{1} ) ( {σ}_{x}^{2} + {σ}_{x}^{2} + {σ}_{x}^{2} + {C}_{2} )}$$

In Equation 11, x may correspond to a deteriorated output image 303, y may correspond to an output image 303, and z may correspond to a truth image. p and a of Equation 11 are the mean and standard deviation, respectively, of the corresponding image (e.g., x, y, z). C of Equation 11 may be an epsilon value (e.g., a designated number set to prevent a zero division error, preferably C¹=0.01², C²=0.03²).

According to an embodiment, the electronic device may perform training on the image restoration model including the sub-model 220-1 in the first state using the difference between the truth data for the input image 302 and the output image 303. The training may be performed based on back propagation. Referring to FIG. 3, in the image restoration model, the information representing the input image 302 may be changed into information representing the output image 303 when propagating in a forward direction (e.g., from the bottom to the top in FIG. 3) from the lower blocks (e.g., the sub-model 220-1 and/or STN operation 241) of FIG. 3 to the decoder 244. The electronic device may propagate information in a reverse direction (e.g., the direction from the bottom to the top in FIG. 3) opposite the forward direction to change parameters and/or weights included in the layers of the image restoration model. When the image restoration model is trained based on back propagation, parameters and/or weights included in the layers of the image restoration model may be changed or tuned based on a gradient descent algorithm.

When training the image restoration model supporting multi-modal including textual information output from the sub-model 220-1 and non-textual information output from the encoder, the electronic device may back-propagate information only in a first direction 311 related to a first portion of the image restoration model for extracting textual information, out of the first direction 311 and a second direction 312 related to a second portion of the image restoration model for extracting non-textual information. In this case, parameters and/or weights included in the layers of the sub-model 220-1 may be changed by information propagating along the first direction 311. For example, when training the image restoration model, propagation of information along the second direction 312 may be at least temporarily stopped.

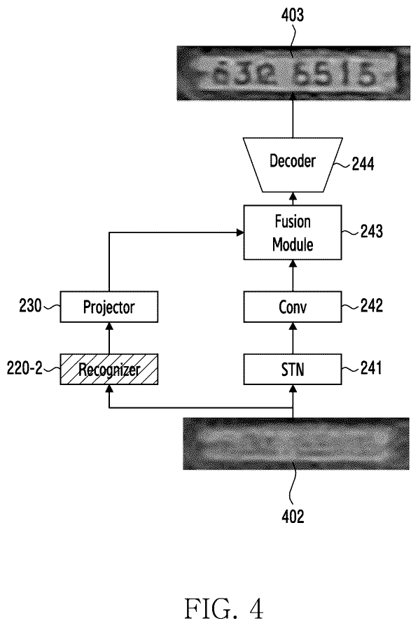

As described above, the electronic device according to an embodiment may preferentially perform back propagation in the first direction 311 related to textual information in the image restoration model to reinforce the dependence of the image restoration model on the sub-model 220-1 configured to generate textual information. Based on the above-described training, the sub-model 220-1 pre-trained by the teacher-model may be additionally trained. Hereinafter, an exemplary operation of an electronic device that executes an image restoration model including an additionally trained sub-model based on the operation of FIG. 3 is described with reference to FIG. 4.

FIG. 4 illustrates an exemplary operation of an electronic device to restore an image using an image restoration model at least partially trained using back propagation. The electronic device 101 and/or the processor 110 of FIG. 1 may execute the image restoration program 125 to obtain or execute the image restoration model trained by the exemplary operation described with reference to FIG. 4. Alternatively, the electronic device 101 and/or the processor 110 of FIG. 1 may execute the image restoration program 125 to perform training on the image restoration model based on the operation described with reference to FIG. 4.

Referring to FIG. 4, an exemplary structure of the image restoration model including a sub-model 220-2 in the second state trained by selective back propagation based on the first direction 311 of FIG. 3 is illustrated. When training the image restoration model to restore the output image 403 from the input image 402, the electronic device may perform training on the image restoration model in a state where the sub-model 220-2 is frozen. According to an embodiment, the electronic device may increase the dependence of the image restoration model on textual information using a loss function that reduces an attention score between the output image 403 and the truth image, and a loss function that reduces a difference between the probability distribution of the truth image and the probability distribution of the output image 403. For example, using the loss function [symbol] ₜₓₜ of Equation 12, the electronic device may train the image restoration model so that the dependence of the image restoration model on textual information increases.

$${ℒ}_{txt} = α \cdot {‖ {A}_{HR} - {A}_{SR} ‖}_{1} + β \cdot WCE ( {p}_{pred} , {y}_{gt} ) \qquad [ Equation 12 ]$$

For example, α of Equation 12 may be set to 10 and β may be set to 0.0005. α and β may denote the respective utilization rates (or dependence) of textual information and non-textual information, respectively. ∥A_{HR}−A_{SR}∥₁ of Equation 12 may mean the L1 distance. A_{HR} and A_{SR} of Equation 12 may be attention information (or attention map) for a high-resolution image and attention information (or attention map) for the output image 403 (e.g., the image restored by the image restoration model), respectively, obtained from an additional artificial intelligence model (e.g., a text recognition network) for processing the output image 403. p_{pred} of Equation 12 may denote text logit information obtained by inputting the output image 403 to the text recognition network. y_{gt} of Equation 12 may denote the truth data. The loss function [symbol] ₜₓₜ of Equation 12 may be defined to reduce the difference between the attention information A_{SR} for the output image 403 and the attention information A_{HR} for the high-resolution image.

According to an embodiment, the electronic device may perform training on the image restoration model using the loss function [symbol] ₜₒₜₐₗ of Equation 13.

$${ℒ}_{total} = {λ}_{1} {ℒ}_{s} + {λ}_{2} {ℒ}_{tssim} + {λ}_{3} {ℒ}_{distill} + {λ}_{4} {ℒ}_{str} + {λ}_{5} {ℒ}_{txt} \qquad [ Equation 13 ]$$

For example, it may be empirically set as values such as λ₁=1, λ₂=1, λ₃=0.01, λ₄=0.01, λ₅=0.5 of Equation 13. Here, λ is a hyper-parameter, and may be a parameter for adjusting the weight of each loss in a network that is multi-trained (joint learning) with the sum [symbol] of the losses in the premise [symbol] ₜₒₜₐₗ.

Hereinafter, a detailed structure of the image restoration model described with reference to FIGS. 1 to 4 is exemplarily described with reference to FIG. 5.

FIG. 5 is an exemplary block diagram illustrating an image restoration model connected to a teacher model 210. The electronic device 101 and/or the processor 110 of FIG. 1 may execute the image restoration program 125 to obtain, generate, and/or train the image restoration model described with reference to FIG. 5.

Referring to FIG. 5, the image restoration model may include a TPS model 511 and a shallow CNN 512. The combination of the TPS model 511 and the shallow CNN 512 may be referred to as an encoder 280 of the image restoration model (e.g., the combination of the STN operation 241 and the convolution operation 242 of FIGS. 2 to 4). From the input image 502, the electronic device may extract low-level feature information by performing calculations indicated by the encoder 280. By performing the calculations indicated by the Flatten model 513 on the feature information, the electronic device may obtain forms of characters having a relatively uniform shape (e.g., Fᵥ of Equation 1).

In the state of processing the input image 502 using the image restoration model, the electronic device may perform a first operation (e.g., the first operation 350 of FIG. 3) of processing the input image 502 using the TPS model 511 and/or the shallow CNN 512 and a second operation (e.g., the second operation 360 of FIG. 3) of processing the input image 502 using the sub-model 220-3 in parallel (or substantially simultaneously). The first operation and the second operation may be performed substantially simultaneously by different processors included in the electronic device. From the sub-model 220-3, the electronic device may obtain or generate text probability information explicitly representing one or more characters related to the input image 502. The text probability information may be referred to as explicit information (or explicit feature information).

The electronic device may process text probability information output from the sub-model 220-3 using the projection model 530. In the projection model 530, the projector 531, the multi-head self-attention model 532, the first layer normalization model 533, the feed forward model 534, and the second layer normalization model 535 may be serially coupled. Using the projection model 530, the electronic device may generate or obtain other feature information to be combined with the feature information generated by the execution of the encoder 580 (e.g., the feature information Fₚ″ of Equation 6).

According to an embodiment, the electronic device may perform multi-head cross-attention between feature information of the shallow CNN 512 and feature information output from the projection model 530 in the multi-head cross-attention model 514 of the image restoration model. Fₚ′″ of Equation 7 may correspond to the result of performing multi-head cross-attention.

The electronic device may perform calculations indicated by the serial connection of the merge model 515, the first layer normalization model 516, the feedforward model 517, and the second layer normalization model 518, on the feature information Fₚ′″ obtained from the multi-head cross-attention model 514. Referring to FIG. 5, a residual connection 516a for element-wise sum may be formed between the first layer normalization model 516 and the second layer normalization model 518. The residual connection 516a may be formed between the first layer normalization model 516 and the second layer normalization model 518 independently of the feed forward model 517.

Referring to FIG. 5, the electronic device may repeatedly perform calculations based on the BiLSTM model 521 N times (e.g., 5 times) on the information obtained from the second layer normalization model 518. A combination of the first convolution model 519, the second convolution model 520, and the BiLSTM model 521 connected to the second layer normalization model 518 may be referred to as a decoder 540. The feature information F of Equation 8 may correspond to the feature information obtained from decoder 540.

In an embodiment, the electronic device may use the pixel shuffle model 522 to increase the resolution and/or size of the image output by the decoder 540 (e.g., an image represented by the feature information F of Equation 8). For example, the restored image, which is the output image 503 output from the pixel shuffle model 522 of the image restoration model, may be represented as Equation 9.

To train the image restoration model described above, a teacher-model 210-3 related to the sub-model 220-3 may be used. The teacher-model 210-3 illustrated in FIG. 5 may include a serial connection between the TPS model 210-3a for TPS operation, the backbone model 210-3b based on ResNet, the BiLSTM 210-3c, the attention model 210-3d, and the linearization model 210-3e. Similarly, the sub-model 220-2 may include a serial connection of the TPS model 220-3a, the backbone model 220-3b, the BiLSTM 220-3b, the attention model 220-3d, and the linearization model 220-3e. The teacher-model 210-3 may be trained to generate text categorical information (e.g., a text probability map) from an image 501 having a resolution larger than that of the input image 502 and/or a size larger than that of the input image 502. The electronic device may determine a loss function (e.g., the loss function [symbol] _{distill} of Equation 4) for knowledge distillation for the sub-model 220-3 using the teacher-model 210-3. The loss function may be calculated using text categorical information (e.g., feature information t_{HR}) obtained from the output layer of the teacher-model 210-3.

By using the difference between the truth image corresponding to the input image 502 and the output image 503 of Equation 9, the electronic device may at least partially train the image restoration model. For example, the electronic device may perform back propagation on the sub-model 220-3 and/or projection model 530 independently (or preferentially) of back propagation related to shallow CNN 512, increasing the utilization rates of sub-model 220-3 and/or projection model 530. The image restoration model including the sub-model 220-3 trained by the back propagation may be provided as a model for restoring the output image 503 from the input image 502.

The performance of the image restoration model according to an embodiment may be measured as shown in Table 1.

TABLE 1

| Acc. | Prior only | Image + Prior | PURE |
|---|---|---|---|
| Baseline | 22.00 | 56.04 | 56.32 |
| Max-Margin Rec. | 44.96 | 56.44 | 56.92 |

Referring to Table 1, for example data sets such as text zoom, performance indicators (e.g., performance indicators in the “PURE” column) of the image restoration model according to an embodiment may be higher than performance indicators of other image restoration models.

As described above, according to an embodiment, the electronic device may execute the image restoration model including a sub-model 220-3 and a projection model 530, which may be executed at least temporarily simultaneously with the models 510 for restoring the input image 502. The models 510 may be combined with a pre-trained sub-model 220-3 for recognizing characters. Using the sub-model 220-3, the electronic device may effectively obtain prior knowledge (or prior information) to be used to restore or enhance the input image 502. The image restoration model may restore or enhance the input image 502 using explicit information output from the sub-model (e.g., one or more characters related to the input image 502, and the relative positions of the one or more characters). Since the input image 502 is restored using text-related information, the electronic device may be trained to interpret the number plate and/or the sign board.

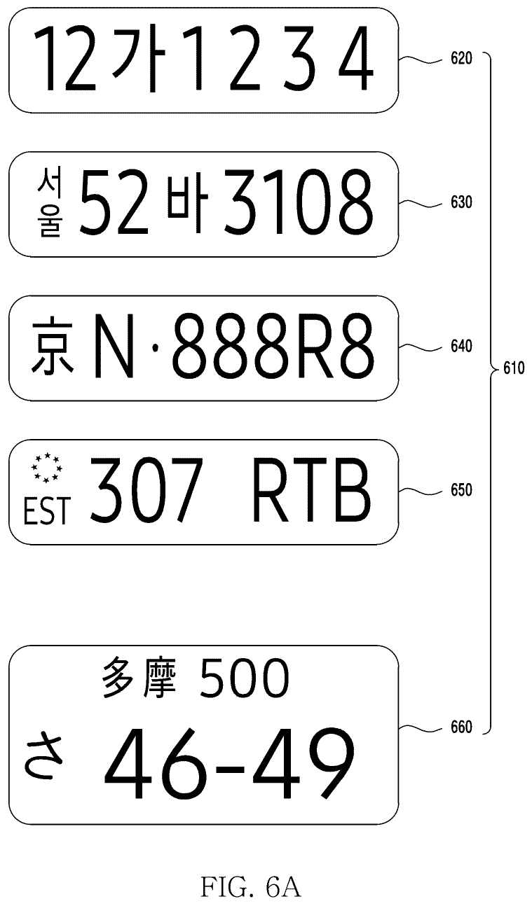

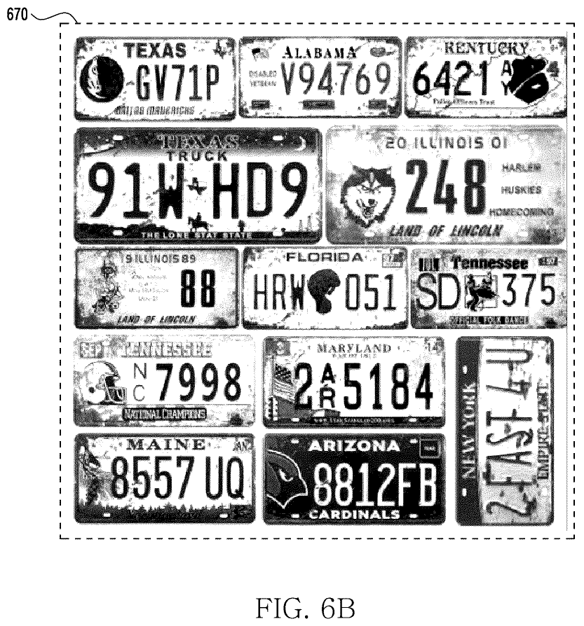

Hereinafter, number plates restored by the image restoration model are exemplarily illustrated with reference to FIGS. 6A and/or 6B.

FIGS. 6A and 6B illustrate at least one license plate (or number plate) which is an object included in an image restored by an image restoration model according to an embodiment.

Referring to FIG. 6A, images 610 including at least one number plate obtained from the image restoration model are illustrated. The images 610 may be output or provided from an electronic device that has executed the image restoration model, as a result of restoring or enhancing a low-resolution input image (e.g., the input image 202 of FIG. 2).

For example, the electronic device may generate an image 620 including a number plate based on the law of the Republic of Korea. The image 620 may include numbers (e.g., 12) indicating the type of the vehicle, characters (e.g., “ [symbol] ”) indicating the purpose of the vehicle, and numbers (e.g., 1234) indicating a serial number uniquely assigned to the vehicle. For example, the electronic device may obtain an image 630 including a number plate based on the law of the Republic of Korea. The image 630 may further include characters (e.g., an area name such as “ [symbol] ”) indicating the area related to the number plate in the image 620. The background color of the number plate represented through the images 620 and 630 may denote the category (e.g., private vehicle) of the vehicle defined by the laws of the Republic of Korea.

For example, the electronic device may generate an image 640 including a number plate based on the law of China. The image 640 may include a character (e.g., indicating the area related to the number plate, and a character (e.g., [symbol] ) indicating the city (e.g., a sub area of the area) related to the number plate, information about the area or purpose. The image 640 may include a serial number (e.g., 688R8) uniquely assigned to the vehicle. The color of the number plate represented through the image 640 may denote the category (e.g., passenger car, large car, bus, truck, and/or motorcycle) of the vehicle.

For example, the electronic device may generate an image 650 including a number plate based on the law of the European Union. The image 650 may include a symbol representing the European Union, characters (e.g., EST) representing the area related to the number plate, and a serial number (e.g., “307 RTB”) uniquely assigned to the vehicle with the number plate. Embodiments are not limited thereto, and the image 650 may further include the national flag of is a country that has joined the European Union, and registered the vehicle with the number plate.

For example, the electronic device may generate an image 660 including a number plate based on the law of Japan. The image 660 may include a character (e.g., [symbol] ) representing an area, a number (e.g., 500) representing the category of the vehicle, characters representing the purpose of the business related to the vehicle, and a serial number (e.g., 46-49) uniquely assigned to the vehicle with the number plate.

Referring to FIG. 6B, images 670 including a number plate based on the law of the United States generated by the electronic device according to an embodiment are illustrated. Referring to the images 670, based on the law of the United States, a number plate including an image and/or a figure defined by the state government of the United States may be generated. The number plate may include text (e.g., “TEXAS”, “ALABAMA”, “KENTUCKY”, etc.) representing the state where the vehicle has been registered, together with the image and/or figure representing the state. Along with the text, the image representing the number plate may include a serial number (e.g., a combination of characters and/or numbers, such as “GV71P”) uniquely assigned to the vehicle.

In an embodiment, a method of generating an image with a second resolution exceeding a first resolution from an image with the first resolution using the image restoration model may be required. In an embodiment, a method of enhancing the restoration performance of a multi-modal image restoration model may be required. As described above, in an embodiment, there may be provided a method of an electronic device. The method may comprise obtaining, from an image, a sub-model trained to output a text probability map indicating one or more characters associated with the image. The method may comprise obtaining, using an input image with a first resolution, an output image with a second resolution larger than the first resolution by executing an image restoration model including an encoder to extract feature information from the input image, a composite module to combine the text probability map of the sub-model for the input image and the feature information, and a decoder connected to the composite module. The method may comprise generating information indicating a result of comparison of a ground truth image corresponding to the input image and the output image. The method may comprise performing training on the image restoration model by performing back propagation based on the generated information along a first direction, out of the first direction from the composite module to the sub-model and a second direction from the composite module to the encoder. According to an embodiment, the electronic device may generate an image with a second resolution larger than the first resolution from the image with the first resolution using the image restoration model. According to an embodiment, the electronic device may perform training on the image restoration model to enhance the restoration performance of the multimodal image restoration model.

For example, the performing may include ceasing to perform the back propagation along the second direction to train the sub-model using the information.

For example, the sub-model may be trained to output the text probability map indicating one or more characters indicated as being captured by the input image and locations of the one or more characters.

For example, the obtaining may include obtaining the sub-model trained using a teacher model executed using parameters more than parameters for the sub-model.

For example, the method may comprise executing the trained image restoration model in response to a request to restore a portion associated with a license plate segmented from a source image.

As described above, according to an embodiment, an electronic device may comprise memory storing instructions and at least one processor configured to execute the instructions. The instructions may, when executed by the at least one processor individually or collectively, cause the electronic device to obtain, from an image, a sub-model trained to output a text probability map indicating one or more characters associated with the image. The instructions may, when executed by the at least one processor individually or collectively, cause the electronic device to obtain, using an input image with a first resolution, an output image with a second resolution larger than the first resolution by executing an image restoration model including an encoder to extract feature information from the input image, a composite module to combine the text probability map of the sub-model for the input image and the feature information, and a decoder connected to the composite module. The instructions may, when executed by the at least one processor individually or collectively, cause the electronic device to generate information indicating a result of comparison of a ground truth image corresponding to the input image and the output image. The instructions may, when executed by the at least one processor individually or collectively, cause the electronic device to perform training on the image restoration model by performing back propagation based on the generated information along a first direction, out of the first direction from the composite module to the sub-model and a second direction from the composite module to the encoder.

For example, the instructions may, when executed by the at least one processor individually or collectively, cause the electronic device to cease to perform the back propagation along the second direction to train the sub-model using the information.

For example, the sub-model may be trained to output the text probability map indicating one or more characters indicated as being captured by the input image and locations of the one or more characters.

For example, the instructions may, when executed by the at least one processor individually or collectively, cause the electronic device to obtain the sub-model trained using a teacher model executed using parameters more than parameters for the sub-model.

For example, the instructions may, when executed by the at least one processor individually or collectively, cause the electronic device to execute the trained image restoration model in response to a request to restore a portion associated with a license plate segmented from a source image.

As described above, in an embodiment, there may be provided a non-transitory computer-readable storage medium including instructions. The instructions may, when executed by the at least one processor of the electronic device individually or collectively, cause the electronic device to receive a request to restore a first image with a first resolution to an image with a second resolution larger than the first resolution. The instructions may, when executed by the at least one processor individually or collectively, cause the electronic device to, based on the received request, execute an image restoration model including an encoder to extract feature information from the first image, a sub-model to determine text probability map with respect to the first image, a fusion layer to combine the text probability map and the feature information, and a decoder connected to the composite module to generate an image with the second resolution. The instructions may, when executed by the at least one processor individually or collectively, cause the electronic device to provide a second image with the second resolution, which is obtained based on execution of the image restoration model, as a response to the request. The image restoration model may be trained based on back propagation performed along a first direction, out of the first direction from the composite module to the sub-model and a second direction from the composite module to the encoder.

For example, the instructions may, when executed by the at least one processor, cause the electronic device to execute the image restoration model trained in a state in which the performing of the back propagation along the second direction is ceased.

For example, the sub-model may be trained to output the text probability map indicating one or more characters indicated as being captured by the first image and locations of the one or more characters.

For example, the sub-model may be pre-trained by a teacher model executed using parameters more than parameters for the sub-model.

For example, the instructions may, when executed by the at least one processor, cause the electronic device to receive, from an external electronic device through communication circuitry of the electronic device, a first signal including the request and a third image. The instructions may, when executed by the at least one processor individually or collectively, cause the electronic device to segment, based on receiving the first signal, a portion associated with a license plate in the third image, as the first image. The instructions may, when executed by the at least one processor individually or collectively, cause the electronic device to transmit, based on obtaining the second image from the restoration model executed using the segmented first image, a second signal including the second image to the external electronic device.

As described above, according to an embodiment, an electronic device may comprise memory storing instructions and at least one processor configured to execute the instructions. The instructions may, when executed by the at least one processor individually or collectively, cause the electronic device to receive a request to restore a first image with a first resolution to an image with a second resolution larger than the first resolution. The instructions may, when executed by the at least one processor individually or collectively, cause the electronic device to, based on the received request, execute an image restoration model including an encoder to extract feature information from the first image, a sub-model to determine text probability map with respect to the first image, a fusion layer to combine the text probability map and the feature information, and a decoder connected to the composite module to generate an image with the second resolution. The instructions may, when executed by the at least one processor individually or collectively, cause the electronic device to provide a second image with the second resolution, which is obtained based on execution of the image restoration model, as a response to the request. The image restoration model may be trained based on back propagation performed along a first direction, out of the first direction from the composite module to the sub-model and a second direction from the composite module to the encoder.

For example, the instructions may, when executed by the at least one processor individually or collectively, cause the electronic device to execute the image restoration model trained in a state in which the performing of the back propagation along the second direction is ceased.

For example, the sub-model may be trained to output the text probability map indicating one or more characters indicated as being captured by the first image and locations of the one or more characters.

For example, the sub-model may be pre-trained by a teacher model executed using parameters more than parameters for the sub-model.

For example, the instructions may, when executed by the at least one processor, cause the electronic device to receive, from an external electronic device through communication circuitry of the electronic device, a first signal including the request and a third image. The instructions may, when executed by the at least one processor individually or collectively, cause the electronic device to segment, based on receiving the first signal, a portion associated with a license plate in the third image, as the first image. The instructions may, when executed by the at least one processor individually or collectively, cause the electronic device to transmit, based on obtaining the second image from the restoration model executed using the segmented first image, a second signal including the second image to the external electronic device.

The above-described devices may be implemented as hardware components, software components, and/or in a combination thereof. For example, the devices and components described herein may be implemented using one or more general-purpose or specific-purpose computers, such as processors, controllers, arithmetic logic units (ALUs), digital signal processors, micro-computers, field programmable gate arrays (FPGAs), programmable logic units (PLUs), micro-processors, any other devices capable of executing and responding to instructions. The processing device or processor may perform an operating system (OS) and one or more software applications performed on the OS. The processing device or processor may access, store, manipulate or control, process, and generate data in response to the execution of the software. For illustration purposes, the processing device or processor may be a single one but it will be appreciated by one of ordinary skill in the art that a processing device may include a plurality of processing elements and/or a plurality of types of processing elements. For example, the processing device may include a plurality of processors or a single processor and a single controller. The server or device may have other various processing configurations, such as parallel processors.

The software may include computer programs, codes, instructions, or combinations of one or more thereof and may configure the processing device as it is operated as desired or may instruct the processing device independently or collectively. The software and/or data may be embodied in any type of machine, component, physical device, computer storage medium, or device so as to provide instructions or data to the processing device or to be interpreted by the processing device. The software may be distributed over computer systems connected together via a network to be distributively stored or executed. The software and data may be stored in one or more computer readable recording media.

The methods according to the embodiments may be implemented in the form of programming commands executable by various computer means, and the programming commands may be recorded in a computer-readable medium. In this case, the medium may continuously store computer-executable programs or temporarily store them for execution or download. Further, the medium may be a variety of recording or storage means in the form of a single piece of hardware or a combination of multiple pieces of hardware and, rather than being limited to a medium directly connected to a computer system, may be distributed over a network. Examples of the medium may include, but is not limited to, magnetic media, such as hard disks, floppy disks or magnetic tapes, optical recording media, such as CD-ROMs or DVDs, magneto-optical media, such as floptical disks, and ROMs, RAMs, or flash memories, or any other types of media configured to store program instructions. Further, examples of other media may include app stores that distribute applications, websites that supply or distribute various pieces of software, and recording media or storage media managed by servers.

Although the disclosure is shown and described in connection with embodiments, it will be easily appreciated by one of ordinary skill in the art that various changes or modifications may be made without departing from the scope of the disclosure. For example, although the techniques described herein are performed in a different order from those described herein and/or the components of the above-described structure or device are coupled, combined, or assembled in a different form from those described herein, or some components are replaced with other components or equivalents thereof, a proper result may be achieved.

Hence, other implementations, other embodiments, and equivalents to the claims also belong to the scope of the claims described below.

What is claimed is:

1. A method of an electronic device comprising:
obtaining, from an image, a sub-model trained to output a text probability map indicating one or more characters associated with the image;
obtaining, using an input image with a first resolution, an output image with a second resolution larger than the first resolution by executing an image restoration model including:
an encoder to extract feature information from the input image;
a composite module to combine the text probability map of the sub-model for the input image and the feature information; and
a decoder connected to the composite module;
generating information indicating a result of comparison of a ground truth image corresponding to the input image and the output image; and
performing training on the image restoration model by performing back propagation based on the generated information along a first direction, out of the first direction and a second direction, the first direction being a direction from the composite module to the sub-model and the second direction being a direction from the composite module to the encoder.

2. The method of claim 1, wherein the performing comprises:
ceasing to perform the back propagation along the second direction to train the sub-model using the information.

3. The method of claim 1, wherein the sub-model is trained to output the text probability map indicating one or more characters indicated as being captured by the input image and locations of the one or more characters.

4. The method of claim 1, wherein the obtaining comprises:
obtaining the sub-model trained using a teacher model executed using parameters more than parameters for the sub-model.

5. The method of claim 1, further comprising:
executing the trained restoration model in response to a request to restore a portion associated with a license plate segmented from a source image.

6. An electronic device comprising:
memory storing instructions; and
at least one processor configured to execute the instructions,
wherein the instructions, when executed by the at least one processor individually or collectively, cause the electronic device to:
obtain, from an image, a sub-model trained to output a text probability map indicating one or more characters associated with the image;
obtain, using an input image with a first resolution, an output image with a second resolution larger than the first resolution by executing an image restoration model including:
an encoder to extract feature information from the input image;
a composite module to combine the text probability map of the sub-model for the input image and the feature information; and
a decoder connected to the composite module;
generate information indicating a result of comparison of a ground truth image corresponding to the input image and the output image; and
perform training on the image restoration model by performing back propagation based on the generated information along a first direction, out of the first direction and a second direction, the first direction being a direction from the composite module to the sub-model and the second direction being a direction from the composite module to the encoder.

7. The electronic device of claim 6, wherein the instructions, when executed by the at least one processor individually or collectively, cause the electronic device to:
cease to perform the back propagation along the second direction to train the sub-model using the information.

8. The electronic device of claim 6, wherein the sub-model is trained to output the text probability map indicating one or more characters indicated as being captured by the input image and locations of the one or more characters.

9. The electronic device of claim 6, wherein the instructions, when executed by the at least one processor individually or collectively, cause the electronic device to:
obtain the sub-model trained using a teacher model executed using parameters more than parameters for the sub-model.

10. The electronic device of claim 6, wherein the instructions, when executed by the at least one processor individually or collectively, cause the electronic device to:
execute the trained image restoration model in response to a request to restore a portion associated with a license plate segmented from a source image.

11. A non-transitory computer readable storage medium comprising instructions, wherein the instructions, when executed by at least one processor of an electronic device individually or collectively, cause the electronic device to:
receive a request to restore a first image with a first resolution to an image with a second resolution larger than the first resolution,
based on the received request, execute an image restoration model including:
an encoder to extract feature information from the first image;
a sub-model to determine text probability map with respect to the first image;
a fusion layer to combine the text probability map and the feature information; and
a decoder connected to the composite module to generate an image with the second resolution; and
provide a second image with the second resolution, which is obtained based on execution of the image restoration model, as a response to the request,
wherein the image restoration model is trained based on back propagation performed, along a first direction, out of the first direction from the composite module to the sub-model and a second direction from the composite module to the encoder.

12. The non-transitory computer readable storage medium of claim 11, wherein the instructions, when executed by the at least one processor, cause the electronic device to:
execute the image restoration model trained in a state in which the performing of the back propagation along the second direction is ceased.

13. The non-transitory computer readable storage medium of claim 11, wherein the sub-model is trained to output the text probability map indicating one or more characters indicated as being captured by the first image and locations of the one or more characters.

14. The non-transitory computer readable storage medium of claim 13, wherein the sub-model is pre-trained by a teacher model executed using parameters more than parameters for the sub-model.

15. The non-transitory computer readable storage medium of claim 11, wherein the instructions, when executed by the at least one processor, cause the electronic device to:
receive, from an external electronic device through communication circuitry of the electronic device, a first signal including the request and a third image.

16. The non-transitory computer readable storage medium of claim 15, wherein the instructions, when executed by the at least one processor, cause the electronic device to:
segment, based on receiving the first signal, a portion associated with a license plate in the third image, as the first image.

17. The non-transitory computer readable storage medium of claim 16, wherein the instructions, when executed by the at least one processor, cause the electronic device to:
transmit, based on obtaining the second image from the restoration model executed using the segmented first image, a second signal including the second image to the external electronic device.

18. The non-transitory computer readable storage medium of claim 11, wherein the sub-model is trained to identify textual information associated with the first image.

19. The non-transitory computer readable storage medium of claim 11, wherein the back propagation along the first direction is performed to increase a rate of utilization of the information inferred by the sub-model.

20. The non-transitory computer readable storage medium of claim 11, wherein the encoder is trained to identify non-textual information associated with the first image.
